(19) United States
(12) Patent Application Publication
(10) Pub. No.: US 2007/0287060 A1
(43) Pub. Date: Dec. 13, 2007

(54) Battery Positive Electrode Material Containing Sulfur and /or Sulfur Compound having S-S Bond, and Process for Producing the Same

(75) Inventors: Katsuhiko Naoi, Tokyo (JP); Nobuhiro Ogihara, Tokyo (JP); Wako Naoi, Tokyo (JP); Noritake Ibuki, Kagawa (JP); Kenji Kato, Kagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: AOI ELECTRONICS CO., LTD., Kagawa (JP); K & W CORPORATION, Tokyo (JP)

(21) Appl. No.: 11/575,709

(22) PCT Filed: Sep. 22, 2005
(86) PCT No.: PCT/JP05/18068

§ 371 Date: Jul. 31, 2007

(30) Foreign Application Priority Data
Sep. 22, 2004 (JP) 2004-276226
Sep. 22, 2004 (JP) 2004-276239
Sep. 22, 2004 (JP) 2004-276254
Sep. 22, 2004 (JP) 2004-307433

(51) Int. Cl. H01M 4/02; C01B 31/26

(52) U.S. Cl. 429/122; 264/105; 423/444

(57) ABSTRACT

A positive electrode material that contains sulfur of high capacitance density as an active material without containing any large amount of conduction aid, namely, a positive electrode material for a battery of high energy density. There is provided a battery positive electrode material comprising a composite of conductive substance and sulfur and/or a sulfur compound having S—S bond, wherein there is disposed a composite microparticle layer having microparticles of conductive material cut into particles of sulfur and/or a sulfur compound having S—S bond. Further, there is provided a process for producing a battery positive electrode material, comprising conducting mechanofusion between particles of sulfur and/or above-mentioned sulfur compound as a raw material and microparticles of conductive material so as to obtain a composite material having a composite microparticle layer wherein the above microparticles are cut into the above particles.

### TECHNICAL FIELD

The present invention relates to a battery positive electrode (cathode) material made of sulfur and/or a sulfur compound having an S—S bond, which contains carbon particles. More particularly, the present invention relates to a positive electrode material of a lithium battery, which has a very high energy density and power density.

### BACKGROUND ART

Recently, a trend toward more convenient portability of communication equipment and OA equipment has been progressed, and competition has been heated up in reducing weight and size of those kinds of equipment. Correspondingly, a higher energy density has been demanded in batteries used as power sources for various kinds of equipment, electric cars, etc. Among the batteries, a lithium battery has hitherto received attention because of no necessity of considering the decomposition voltage of water and potentiality of a higher voltage with proper selection of a positive electrode material. A typical positive electrode material of such a lithium battery is a metal oxide. Above all, manganese dioxide is one of practically most-expectable positive electrode materials because manganese is abundant in the natural world and is inexpensive.

However, the lithium battery using manganese dioxide as the positive electrode material has a problem that its capacity is small. With the view of solving that problem, a battery using, as a positive electrode, a mixture of manganese dioxide and another material mixed at a predetermined ratio is proposed (Patent Document 1).

On the other hand, in order to realize a battery with a high energy density, it is preferable to use an active material having a large specific capacity (capacity density). As a material of the battery positive electrode, for example, it is known that sulfur has a maximum specific capacity among the known materials. More specifically, as shown in FIG. 1, when S₈ is completely reduced to Li₂S (utilization factor 100%), the theoretical specific capacity per weight of the material is 1675 Ah/kg that is larger than the specific capacities of other chemical species.

By utilizing such a characteristic of sulfur, a battery is proposed which has a positive electrode using, as an active material, sulfur with a high specific capacity (Patent Document 2).

In these years, studies have been made with attention focused on, in addition to active sulfur, other sulfur compounds including polycarbon sulfide and organic disulfide compounds. Those two typical sulfur-based compounds also exhibit high theoretical specific capacities ranging from 3 to 13 times at maximum in comparison with general conducting polymer and various lithium metal oxides. The inventors have previously proposed “A method of designing a novel compound wherein, when designing an energy storage device material from a heterocyclic organosulfur compound, an increase in disulfide part and polysufidation are combined for an increase in theoretical specific capacity”, and filed an international patent application (Patent Document 3).

| | |
|---|---|
| Patent Document 1 | Japanese Patent Laid-Open H8-213018 |
| Patent Document 2 | U.S. Pat. No. 5,523,179 |
| Patent Document 3 | WO 02/082569 |

### DISCLOSURE OF THE INVENTION

### Problems to be Solved by the Invention

Because the electron conductivity of sulfur and/or a sulfur compound having an S—S bond is as very low as 5×10⁻³⁰ S·cm⁻¹ at the room temperature, a large amount of conductive additives has to be added. Usually, a proportion of sulfur in an electrode is 50-60 weight % at an upper limit. Also, it is known that a capacity utilization factor of sulfur is about 50-70%. Assuming, for example, that the content of sulfur in a positive electrode material is 50%, the specific capacity of sulfur is 600 Ah/kg at an upper limit in consideration of the sulfur content (50%) in the electrode and the upper limit (70%) of the capacity utilization factor of sulfur. Thus, about 35% of the theoretical specific capacity is just obtained. In order to realize a higher capacity, the content of sulfur or the sulfur compound has to be increased.

However, low electron conductivity of sulfur requires an excessive amount of conductive additives to obtain sufficient electron recovery paths. An upper limit of the sulfur content has, therefore, been restricted to about 50 weight % at maximum by using other known particle combining processes, e.g., a wet process.

Also, since sulfur viscosity is increased when it is mixed in the wet process, a difficulty arises in workability because of a tendency to re-agglomerate. For that reason, the sulfur content cannot be increased.

Another disadvantage is that, because the oxidation—reduction reaction of sulfur is slow and resistance of the electrode reaction is large, a low voltage of 2 V or below can be just obtained when a battery using metal lithium, as a negative electrode (anode), is operated at the room temperature.

In view of the above-mentioned problems in the art, an object of the present invention is to provide a positive electrode material using, as an active material, sulfur having a high specific capacity, i.e., a positive electrode material suitable for a battery with a high energy density, while utilizing such a characteristic of sulfur as having a maximum specific capacity without containing a large amount of conductive additives.

### Means for Solving the Problems

The present invention resides in a battery positive electrode material set forth in the following (1)-(8).

(1) A battery positive electrode material comprising a composite of a conductive substance and sulfur and/or a sulfur compound having an S—S bond, wherein a composite microparticle layer is formed in a state that microparticles of the conductive substance are intruded into particles of the sulfur and/or the sulfur compound having an S—S bond.

(2) In the battery positive electrode material of above (1), the composite microparticle layer is a layer containing the microparticles of the conductive substance closely compacted onto surfaces of the particles of the sulfur and/or the sulfur compound having an S—S bond, which serve as core, while ensuring sufficient electron and ion conduction paths.

(3) In the battery positive electrode material of above (1) or (2), in a state of raw materials, the particles of the sulfur and/or the sulfur compound having an S—S bond have particle diameters of 75 μm or less, and the microparticles of the conductive substance are carbon microparticles with primary particle diameters of 30 nm to 50 nm.

(4) In the battery positive electrode material of above (3), the carbon microparticles have a hollow structure with a porosity of 60 Vol % to 80 Vol %.

(5) In the battery positive electrode material of above (1) to (4), the composite contains the sulfur and/or the sulfur compound having an S—S bond at a content of 70 weight % or more in terms of sulfur.

(6) In the battery positive electrode material of above (5), the composite contains the sulfur and/or the sulfur compound having an S—S bond at a content of 72.9 weight % or more in terms of sulfur.

(7) In the battery positive electrode material of above (1) to (6), the composite has electric conductivity of 10⁰ to 10¹ S·cm⁻¹ or more.

(8) In the battery positive electrode material of above (1) to (7), an energy density per volume is 1000 to 4000 Wh/L and power density is 40 to 4000 W/L.

Also, the present invention resides in a process for producing a battery positive electrode material set forth in the following (9)-(12).

(9) A process for producing a battery positive electrode material, the process comprising the step of performing mechnofusion of particles of sulfur and/or a sulfur compound having an S—S bond with microparticles of a conductive substance, which are used as raw materials, thereby obtaining a composite substance having a composite microparticle layer in which the microparticles are intruded into the particles.

(10) In the process for producing a battery positive electrode material of above (9), in a state of the raw materials, the particles of the sulfur and/or the sulfur compound having an S—S bond have particle diameters of 75 μm or less, and the microparticles of the conductive substance are carbon particles with primary particle diameters of 30 nm to 50 nm.

(11) In the process for producing a battery positive electrode material of above (9) or (10), the carbon microparticles have a hollow structure with a porosity of 60 Vol % to 80 Vol %.

(12) In the process for producing a battery positive electrode material of above (9), (10) or (11), the composite contains the sulfur and/or the sulfur compound having an S—S bond at a content of 72.9 weight % or more in terms of sulfur.

### Effect of the Invention

The present invention can provide a lithium ion battery which has an increased current density by ensuring sufficient conduction paths of both electrons and ions even with a smaller content of the conductive substance, and which has a high operating voltage and a very large energy density and power density by changing the structure of sulfur or a sulfur compound.

Also, since a dry process is used to produce the battery positive electrode material, the sulfur content can be increased in comparison with the case using a wet process, and superior workability is obtained in formation of an electrode.

Further, since the carbon microparticles and the sulfur particles both used as the raw materials are inexpensive and have superior cost efficiency, a battery with a high energy density and a high power density can be provided inexpensively.

### BRIEF DESCRIPTION OF THE DRAWINGS

FIG. 1 is a graph showing theoretical specific capacities of currently-used positive electrode materials for lithium ion batteries.

FIG. 2 is an illustration showing an ideal mixed state of sulfur and conductive additives.

FIG. 3 is an illustration for explaining a discharge reaction in a lithium/sulfur-based battery.

FIG. 4 is a photo of Ketjen Black (registered trademark; notation of “registered trademark” is omitted, as appropriate, in the following description), which was taken using a transmission electron microscope.

FIG. 5 is an illustration of a sulfur particle coated on its surface with nano-carbon particles.

FIG. 6 is a photo (×1000) of a composite substance according to the present invention, which was taken using a scanning electron microscope (SEM).

FIG. 7 is a photo (×1000) of a sulfur particle, which was taken using the scanning electron microscope (SEM).

FIG. 8 is a graph showing a pore volume distribution of Ketjen Black only.

FIG. 9 is a graph showing a pore volume distribution of the composite substance according to the present invention.

FIG. 10 is a graph showing discharge capacities of the composite substances containing different amounts of sulfur.

FIG. 11 is a flowchart of steps for producing a fibrous composite substance.

FIG. 12 is an illustration for explaining changes of sulfur composition in heating and cooling steps.

FIG. 13 is an illustration showing one example of a process for producing a fibrous intermediate composite substance.

FIG. 14 is a photo of the fibrous intermediate composite substance before pulverization, which was taken using the scanning electron microscope at a magnification of 200 times.

FIG. 15 is a photo of the fibrous intermediate composite substance before pulverization, which was taken using the scanning electron microscope at a magnification of 2000 times.

FIG. 16 is a photo of the fibrous intermediate composite substance before pulverization, which was taken using the scanning electron microscope at a magnification of 25000 times.

FIG. 17 is a photo of the fibrous intermediate composite substance before pulverization, which was taken using the scanning electron microscope at a magnification of 70000 times.

FIG. 18 is a photo of the fibrous intermediate composite substance before pulverization, which was taken using the scanning electron microscope at a magnification of 70000 times.

FIG. 19 is a photo of the fibrous intermediate substance after pulverization in the direction looking of a cross-section, which was taken using the scanning electron microscope at a magnification of 800 times.

FIG. 20 is a photo of the fibrous intermediate substance after pulverization, which was taken using the scanning electron microscope at a magnification of 35000 times.

FIG. 21 is a photo of the fibrous intermediate substance after pulverization, which was taken using the scanning electron microscope at a magnification of 18000 times.

FIG. 22 is an illustration showing steps of forming the fibrous composite substance.

FIG. 23 is an illustration of a combining apparatus to perform a mechanochemical reaction.

FIG. 24 is a set of photos (×1000) of a composite substance A and a substance B, which were taken using the scanning electron microscope (SEM).

FIG. 25 shows the structure of a battery used in Examples for comparative measurement.

FIG. 26 is a graph comparatively showing discharge capacities of positive electrode materials mixed in accordance with different combining processes.

FIG. 27 is a set of SEM images of a composite substance C, a substance D, and a substance E, which were taken at magnifications of 500 and 3000 times for each image.

FIG. 28 comparatively show discharge capacities and volumes of positive electrode materials mixed in accordance with different combining processes.

FIG. 29 is a graph showing the comparison results of the discharge capacities per weight in Example 3.

FIG. 30 is a graph showing comparison results of the discharge capacities per volume in Example 3.

FIG. 31 is a table showing mixed ratios of elemental sulfur to Ketjen Black in the mechanochemical bonding process.

FIG. 32 is a set of photos of the composite substances A to C, which were taken using the scanning electron microscope (SEM).

FIG. 33 is a graph showing the result of a thermal analysis of the composite substance A.

FIG. 34 is a graph showing details of the analysis result of a weight ratio between the sulfur compound and Ketjen Black in the composite substance A.

FIG. 35 is a set of graphs showing main points of the analysis results of weight ratios between the sulfur compound and Ketjen Black in the composite substances A to C.

FIG. 36 is a set of graphs showing Raman spectra of the composite substances A to C and the elemental sulfur.

FIG. 37 illustrates images showing coated states of the composite substances A to C.

FIG. 38 shows a screwed-in battery cell used for measuring the discharge capacities of the composite substances A to C.

FIG. 39 shows the result of calculating current values of the composite substances A to C in accordance with a constant current process.

FIG. 40 is a graph showing the discharge curves and the specific capacities of the composite substances A to C.

FIG. 41 is a graph showing peak intensity ratios of the Raman spectra of the composite substances A to C.

FIG. 42 is a set of graphs showing the relationships between the Raman peak intensity ratios and the conductivities and between the Raman peak intensity ratios and the specific capacities of the composite substances A to C.

FIG. 43 is a graph showing discharge curves and corresponding specific capacities of the composite substance and the fibrous composite substance in battery cells.

FIG. 44 is a graph showing endothermic changes of sulfur only and the composite substances A to C with respect to a temperature rise up to 130° C.

FIG. 45 is a graph showing endothermic changes of sulfur only, the fibrous composite substance A, and the composite substances B, C with respect to a temperature rise of 150 to 175° C.

FIG. 46 is a graph showing differential thermal changes of the composite substance B and the fibrous composite substance A with respect to a temperature rise.

FIG. 47 is a set of graphs showing the results of pore areas per weight with respect to pore distributions of Ketjen Black, acetylene black, the fibrous composite substance A, and the composite substance A.

FIG. 48 is a graph showing the distribution results of pore areas per weight with respect to pore distributions of Ketjen Black, acetylene black, the fibrous composite substance A, and the composite substance A.

FIG. 49 is a set of graphs showing changes of pore volume and changes of pore volume distribution with respect to the pore distribution of Ketjen Black, which were measured by the mercury intrusion/extrusion process.

FIG. 50 is a set of graphs showing changes of pore volumes and changes of pore volume distributions with respect to the pore distributions of Ketjen Black, acetylene black, the fibrous composite substance A, and the composite substance A, which were measured by the mercury intrusion/extrusion process.

FIG. 51 is a set of graphs showing changes of pore volumes and changes of pore volume distributions with respect to the pore distributions of Ketjen Black, acetylene black, the fibrous composite substance A, and the composite substance A in the range of 1 nm to 100 nm, which were measured by the mercury intrusion/extrusion process.

### BEST MODE FOR CARRYING OUT THE INVENTION

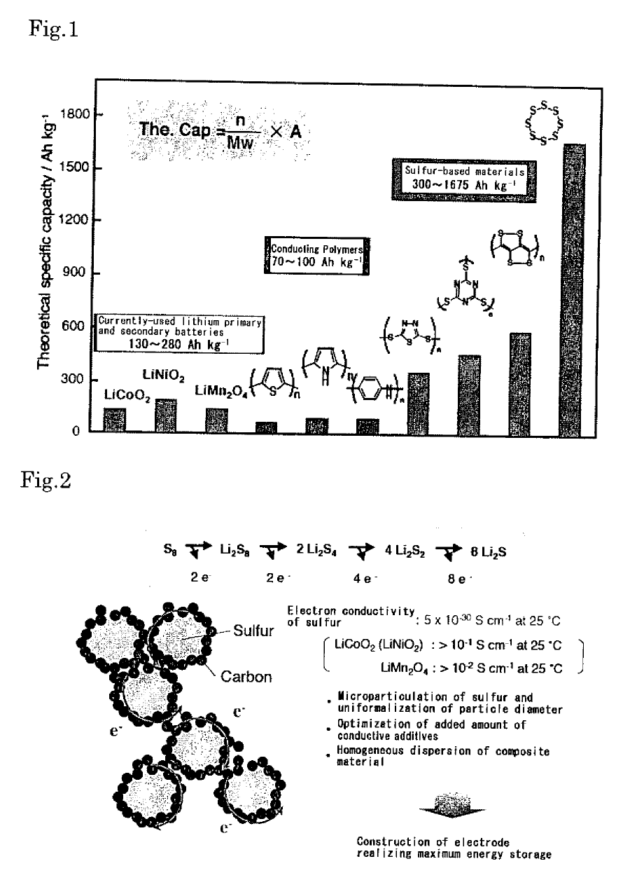

Example of sulfur and/or a sulfur compound having an S—S bond used in the present invention are sulfur, polycarbon sulfide, and organic disulfide compounds. Those three typical sulfur-based compounds exhibit high theoretical specific capacities ranging from 3 to 13 times at maximum in comparison with general conducting polymers and various lithium metal oxides. FIG. 1 shows theoretical Gravimetric Energy Density (Ah/kg) of materials which have been so far considered for use as positive electrodes of lithium batteries. The theoretical specific capacity can be obtained from a ratio (n/Mw) of the number of reaction electrons (n) to the molecular weight (Mw). While lithium transition metal oxides used as positive electrode materials of current lithium ion secondary batteries have values of 130-280 Ah/kg and conducting polymers have values of 70-100 Ah/kg, the sulfur-based compounds have values of 300-1675 Ah/kg. Therefore, the sulfur-based compounds are expected as materials for increasing the battery specific capacity.

For the battery positive electrode, the present invention employs elemental sulfur (S₈) having a cyclic structure and/or a sulfur-based compound, e.g., an organic sulfur compound (—(—R—Sₙ—R—)ₘ—: n is 2 to 8 and m is 2 to 10) having an organic skeleton. Any of those materials has therein a disulfide bond (—S—S—) or a polysulfide bond (—Sₙ—) which contains a chain of disulfide bonds. The sulfur used herein is electrochemically active elemental sulfur. In a sulfur-based positive electrode, the sulfur (S₈) reacts with lithium to produce Li₂S. Its specific capacity is as very high as 1675 Ah/kg. Thus, the sulfur (S₈) is a very attractive substance because, assuming voltage to be 2 V, its energy density is 3340 Wh kg⁻¹, i.e., 17 times 137 Wh kg⁻¹ of LiCoO₂. As shown in FIG. 2, the elemental sulfur changes from S₈ to Li₂S₈, Li₂S₄, Li₂S₂, and then to Li₂S through reduction reactions. The number of reaction electrons obtained in those reactions is 16. Stated another way, when the sulfur or the sulfur compound is used in the positive electrode of the lithium battery, the elemental sulfur changes from S₈ to 8Li₂S through reduction reactions and the number of electrons used in those reactions is 16. Therefore, a ratio of the number of reaction electrons to the amount of an active material is larger than those of other materials. However, the electron conductivity of the elemental sulfur is about 5×10⁻³⁰ S·cm⁻¹ at the room temperature (25° C.) that is much lower than those of other positive electrode materials (lithium transition metal oxides currently used as the positive electrode materials: 10⁻²-10⁻¹ S·cm⁻¹). Hence the elemental sulfur cannot be used as the positive electrode material as it is.

As one example of the sulfur compound, a polycarbon sulfide compound [(CSₓ)ₙ] containing carbon (C) as R of (SRS)ₙ is charged and discharged while keeping a polymer state, and has an energy density of at least 680 Ah/kg. Thus, it is expected to have a value twice or more those of general oxide electrodes. Although various kinds of polycarbon sulfide compounds are known, the compound having a larger value of y/x in CₓS_{y} is of course more advantageous from the viewpoint of energy density.

Also, the organic disulfide compound is applicable to storage of energy through its oxidation—reduction reactions that when an organic sulfur compound (mercaptan or thiol) having a mercaptan group (—SH group) in a molecule is oxidized, a disulfide bond (—S—S—) is formed, and when it is reduced, the disulfide bond is returned to thiol. By applying formation of the S—S bond by the oxidation reaction to charge of the battery and applying cleavage of the S—S bond by the reduction reaction to discharge of the battery, the organic sulfur compound can be used as the positive electrode material of the lithium battery. The theoretical specific capacity of the organic sulfur compound is 650-1240 Wh kg⁻¹ that is higher than those of a lead acid battery and a nickel cadmium battery by an order of magnitude. In addition, from the viewpoints of price and low toxicity of the material as well, the organic sulfur compound has high potentiality as the battery material for realizing a higher energy density.

Examples of typical organic disulfide compounds are 2,5-dimethylcapto-1,3,4-thiazole (DMcT), trithiocyanuric acid (TTCA), and 5-methyl-1,3,4-thiadiazole-2-thiol (MTT) each of which has a carbon atom at position α, including disulfide, trisulfide and tetrasulfide compounds thereof. However, the organic disulfide compound has a serious drawback when it is used as the positive electrode material of the lithium battery. Namely, because the organic disulfide compound is an insulating material, the conductive additives have to be added, thus canceling off its major advantage, i.e., a high specific capacity.

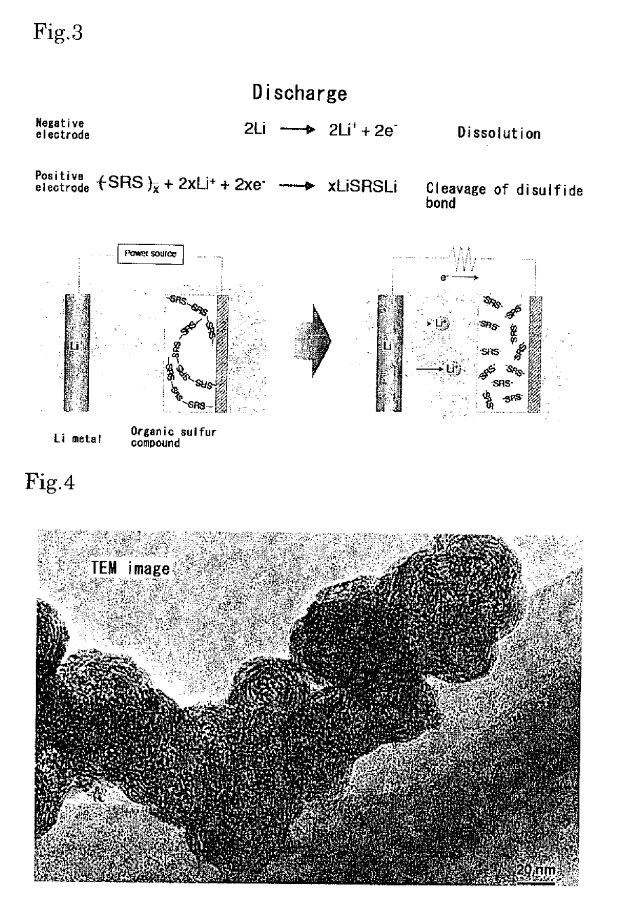

The discharge reaction of a lithium/sulfur battery is now described. A lithium metal (Li⁰) is used as a negative electrode (anode), and elemental sulfur (S₈) having a cyclic structure and/or a sulfur-based compound, e.g., an organic sulfur compound (—(—R—Sₙ—R—)ₘ—: n is 2 to 8 and m is 2 to 10) having an organic skeleton is used as a positive electrode (cathode). Any of those materials has therein a disulfide bond (—S—S—) or a polysulfide bond (—Sₙ—) which contains a chain of disulfide bonds. As shown in FIG. 3, in a discharge state, an oxidation reaction (dissolution reaction) occurs at the negative electrode and Li⁰ changes to Li⁺. Also, as shown in FIG. 3, in the discharge state, a reduction reaction (cleavage reaction of the disulfide bond) occurs at the positive electrode and —S—S— changes to 2S⁻.

When using elemental sulfur or the like, a large amount of carbon materials serving as conductive additives, called carbon black or acetylene black, has hitherto been required to perform recovery and donation of electrons (i.e., oxidation and reduction) based on low electron conductivity. In the present invention, carbon or metal supported carbon having a catalytic effect can be used as a conductive substance that is one of raw materials for producing the composite substance. Commercially available carbon black has high conductivity and is very convenient in handling.

Carbon microparticles preferably have primary particle diameters of 30 nm to 50 nm and a hollow structure with a porosity of 60 Vol % to 80 Vol %. Such carbon microparticles are commercially available as Ketjen Black (registered trademark). FIG. 4 is a photo of Ketjen Black, which was taken using a transmission electron microscope (TEM).

Usually, primary particles of the carbon material serving as the conductive additives are in the form of spheres with diameters of about 30-40 nm, and primary particles of the elemental sulfur are particles with diameters of about 70-100 μm. The sulfur or the sulfur compound used in the present invention preferably has the particle diameter of 75 μm or less. By forming a very thin layer of the carbon microparticles over surfaces of the sulfur or sulfur compound particles, the battery positive electrode can be produced in which the content of the sulfur or the sulfur compound is 72.9 weight % or more and electrical conductivity is 10⁰ to 10¹ S·cm⁻¹ or more.

When the sulfur or the sulfur compound is used as the battery positive electrode material, an ideal structure is such one as shown in FIG. 2, where the conductive additives covers around the elemental sulfur particles. For example, the positive electrode is fabricated through the steps of mixing a composite material of the elemental sulfur and the carbon material serving as the conductive additives in an organic solvent, e.g., n-methylpyrrolidone, to produce ink, applying the ink over a sheet of copper or aluminum, which serves as a current collector, and drying the coated ink, thereby forming, on the current collector, a structure in which the carbon material serving as the conductive additives uniformly covers around the elemental sulfur as shown in FIG. 2. Important factors required in the process of the electrode fabrication are microparticulation of the sulfur, uniformalization of the microparticles, optimization of the added amount of the carbon material serving as the conductive additives, and homogeneous dispersion of the added carbon material.

In order to sufficiently utilize the material characteristics of the sulfur and/or the sulfur compound having an S—S bond, according to the present invention, the above-described problems are overcome by minimizing the content of the conductive additives (addition in the optimum amount), obtaining uniform fine particles of the sulfur and the sulfur compound, and realizing homogeneous dispersion of the composite material. The inventors have succeeded in forming a very thin layer of the conductive additives over surfaces of the sulfur or sulfur compound particles by mechanofusion. Stated another way, by performing the mechanofusion of the particles of the sulfur and/or the sulfur compound having an S—S bond with the microparticles of the conductive substance, a composite microparticle layer is formed in a state where the microparticles are intruded into particles.

By homogeneously dispersing the composite particles obtained with such a process, conduction paths of both electrons and ions are ensured even with a smaller content of the conductive substance, thus enabling larger energy to be stored.

The term “mechanofusion” means a dry mechanical combining technique for applying mechanical energy to plural different kinds of material particles to cause a mechanochemical reaction, thereby creating a new material. Recently, it has been apparent that, by applying a certain kind of mechanical energy to plural different kinds of material particles, there occurs a reaction to cause the mechanofusion (surface fusion). Such a technique is a simpler process than the other particle combining processes, such as a wet process, and is advantageous in having a much wider range of combinations. The term “mechanochemical reaction” means a chemical interaction of a solid in its highly excited state with surrounding substances under application of mechanical energy.

More specifically, the composite particles having firm joining interfaces can be formed through two stages, i.e., a stage where hetero microparticles adhere to surfaces of core particles activated by being subjected to a mechanical action, and a stage where, after some amount of the hetero microparticles have adhered to the surfaces of the core particles, additional microparticles are further laminated and a microparticle layer is itself closely compacted, to thereby form a composite microparticle layer.

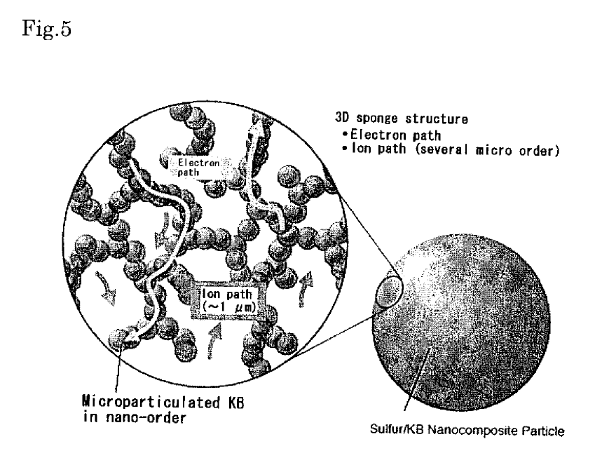

According to the present invention, as shown in FIG. 5, a layer of the conductive substance microparticulated in nano-order size is formed on the surface of the sulfur particle, whereby the conduction paths of both electrons and ions are ensured and a higher specific capacity can be obtained. In the composite microparticle layer formed through the combining process by the mechanofusion, the microparticles of the conductive substance are intruded into the particles of the sulfur and/or the sulfur compound having an S—S bond. Stated another way, as shown in FIG. 5, the present invention provides a composite material in which the sulfur-based compound is uniformly coated with Ketjen Black in the form of a nano-size layer. Thus, combining Ketjen Black and the sulfur-based compound with each other at a nano-size level produces a novel composite material in which the Ketjen Black gives the conduction paths of both electrons and ions to the sulfur-based compound. By uniformly coating the sulfur-based compound with a thin layer of Ketjen Black, as shown in FIG. 5, the conduction paths of electrons are formed and a structure ensuring efficient impregnation of an electrolyte is obtained with nano-size voids formed by the hollow structure of the Ketjen Black. Further, a structure ensuring more efficient impregnation of an electrolyte is obtained with micro-size voids formed by the string-of-beads structure of the Ketjen Black.

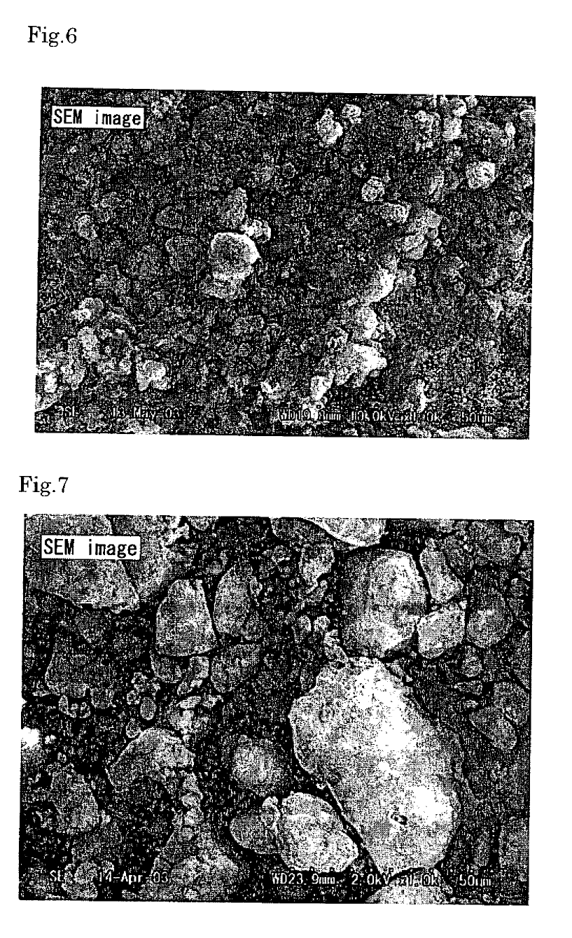

The composite microparticle layer will be described in more detail. FIG. 6 is a photo of sulfur used as raw materials and composite particles combined by the mechanofusion, which was taken using a scanning electron microscope (SEM). The sulfur as raw materials (see FIG. 7) contain particles with diameters of about 20-50 μm, while particle diameters of the composite substance are reduced to about 5-10 μm. Also, the particle shape approaches a sphere through the combining process by the mechanofusion.

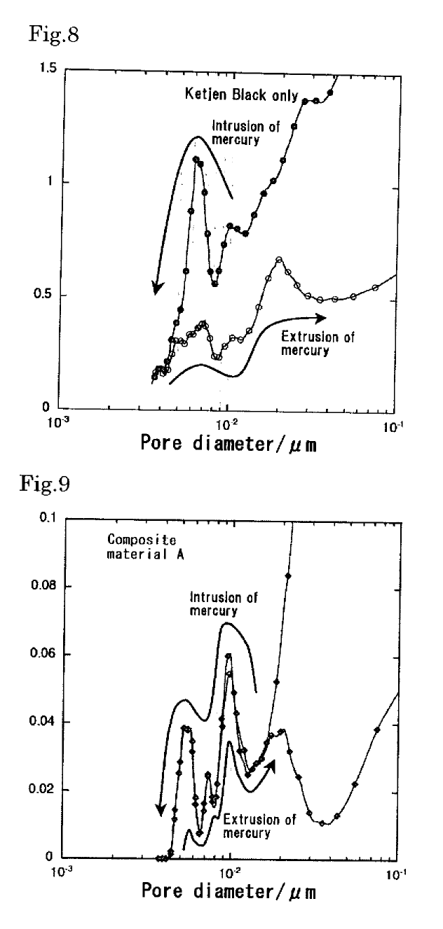

FIG. 8 shows a pore volume distribution of Ketjen Black alone, which is obtained by measurement using a mercury porosimeter, and FIG. 9 shows a pore volume distribution of the composite substance. The term “measurement using a mercury porosimeter” means measurement capable of estimating a surface area, pore distribution, and pore volume by the mercury intrusion/extrusion process into a sample under pressure. In other words, the powder state can be measured by observing routes of the mercury intrusion/extrusion process. In the measurement of Ketjen Black alone, a path of a differentiated value of pore volume change with respect to the pore diameter is not matched between the mercury intrusion/extrusion process. This is because agglomerates formed by gathering of primary particles were scattered away upon the intrusion of mercury. On the other hand, in the measurement of the composite substance, a path of a differentiated value of pore volume change with respect to the pore diameter is matched between the mercury intrusion/extrusion process at the pore diameter of 20 nm or less. This means that primary particles of Ketjen Black or agglomerates thereof are present without being scattered away. It is hence understood that the composite particles combined by the mechanofusion form the composite microparticle layer in which the Ketjen Black is intruded into the sulfur.

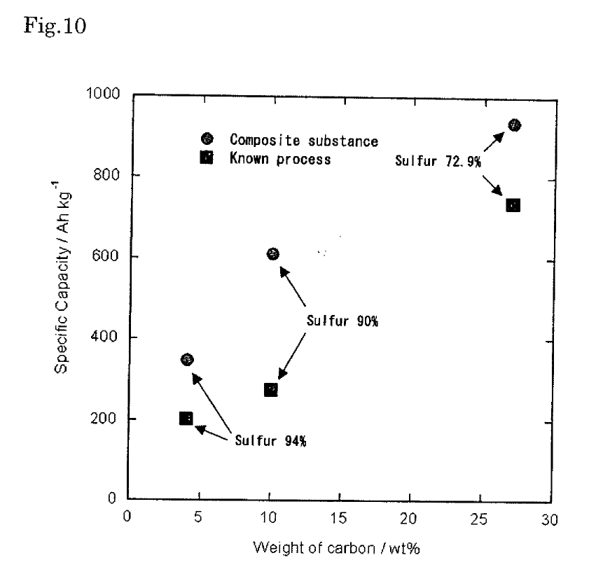

With the above-described production process, the sulfur content can be increased to 73% or more. However, as shown in FIG. 10, there appears a phenomenon that the discharge capacity is reduced as the sulfur content is increased. Such a phenomenon is presumably attributable to that the conduction paths of electrons and ions are not formed at a sufficient level due to a decrease in the content of the conductive additives. Accordingly, optimization of the mechanofusion process is required to ensure the conduction paths of electrons and ions at a sufficient level.

By adding the following steps, the sufficient conduction paths of electrons and ions can be formed even at a smaller content of the conductive additives.

More specifically, a fibrous composite substance having the sufficient conduction paths of electrons and ions can be produced through a first step of performing mechnofusion of particles of sulfur or a sulfur compound with conductive microparticles, to thereby produce a composite substance, a second step of heating the composite substance, formed in the first step, to temperature not lower than the melting point of the sulfur or the sulfur compound, a third step of applying physical stress to the composite substance in a heated state by stirring or elongation, a fourth step of cooling the heated composite substance to the room temperature, to thereby produce a fibrous intermediate composite substance, a fifth step of pulverizing the fibrous intermediate composite substance, and a sixth step of performing mechnofusion of pulverized particles of the fibrous intermediate composite substance with the conductive particles.

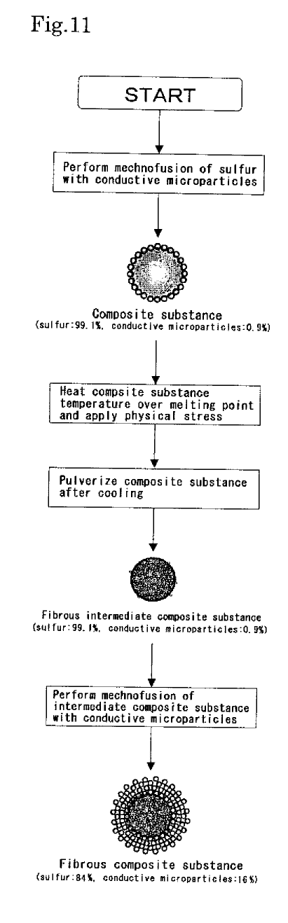

Those steps are shown in a flowchart of FIG. 11.

In the fourth step, the sulfur or the sulfur compound causes change of the internal structure in the phase transition temperature range of 100-120° C. To minimize the change of the internal structure, the composite substance is preferably rapidly cooled to the room temperature at a rate of 50° C.-200° C. per minute by natural cooling or by using a coolant, a heat sink or the like.

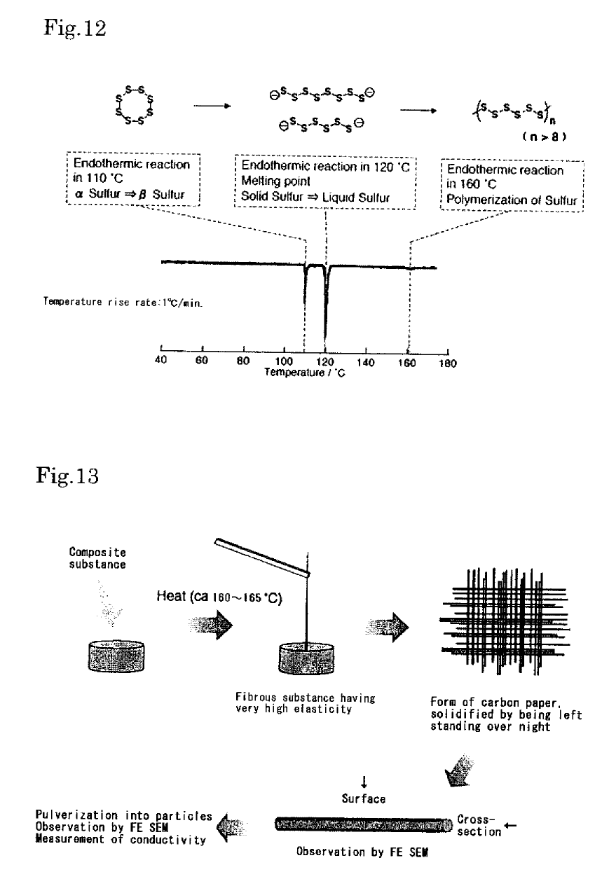

It is deemed that the sulfur structure is changed through the above-mentioned steps (see Reference Example 2 described later). More specifically, as shown in FIG. 12, a discharge characteristic of a high operating voltage is obtained with polymerization of sulfur, which usually has the structure of S₈, with high molecular weight and a higher energy density can be realized in a battery using the polymerized sulfur as a positive electrode. Also, through the third step, carbon particles within the molten sulfur or sulfur compound are mixed with each other at a nano-level, thus forming a mesh-like structure. As a result, sufficient conduction paths of electrons and ions are formed inside the composite substance, whereby discharge can be developed at a larger current and the power density of the battery can be increased.

In short, the battery positive electrode material is produced as follows. The particles of sulfur and/or the sulfur compound having an S—S bond and the microparticles of the conductive substance are combined with each other by the mechanofusion to form the composite substance having the composite microparticle layer in which the microparticles are intruded into the particles. The thus-formed composite substance is used as a starting substance and heated to temperature not lower than the melting point. Physical stress is applied to the composite substance under the heated state by stirring or elongation, followed by cooling to the room temperature. The resulting fibrous intermediate composite substance is pulverized. The pulverized substance and the microparticles of the conductive substance are further combined with each other by the mechanofusion to obtain the battery positive electrode material made of the conductive fibrous composite substance having a three-dimensional network structure constituted by the microparticles of the conductive substance, which coat the surface of the fibrous intermediate composite substance serving as a core.

FIG. 13 shows one example of a process for producing the fibrous intermediate composite substance. The composite substance was heated to 160-165° C. By holding the temperature of 160-165° C., the composite substance was brought into a fluidized state. The fibrous intermediate composite substance in the fluidized state was stirred and elongated. After elongating the composite substance in the fluidized state, it was cooled to the room temperature. The surface and cross-section of a formed fibrous composite substance were observed using a scanning electron microscope. Further, the formed fibrous composite substance was pulverized and resulting particles were observed using the scanning electron microscope.

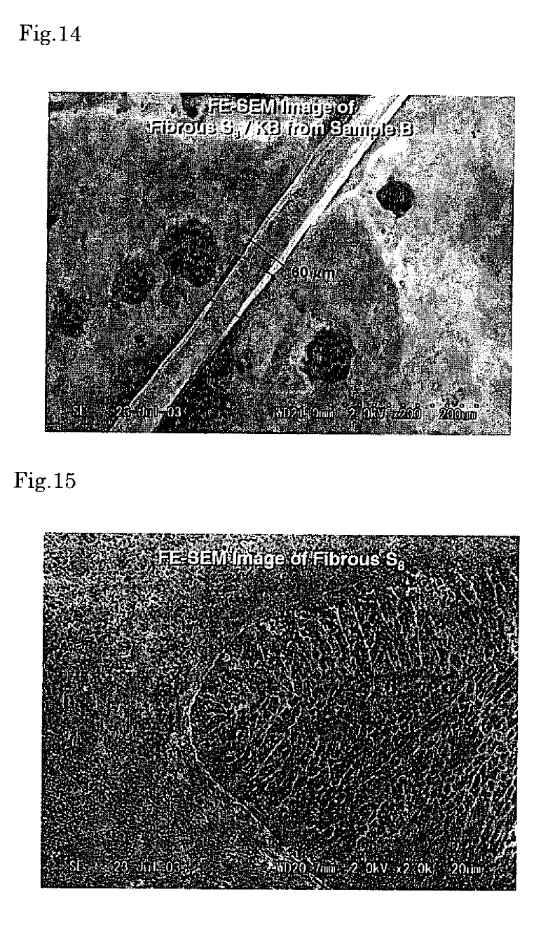

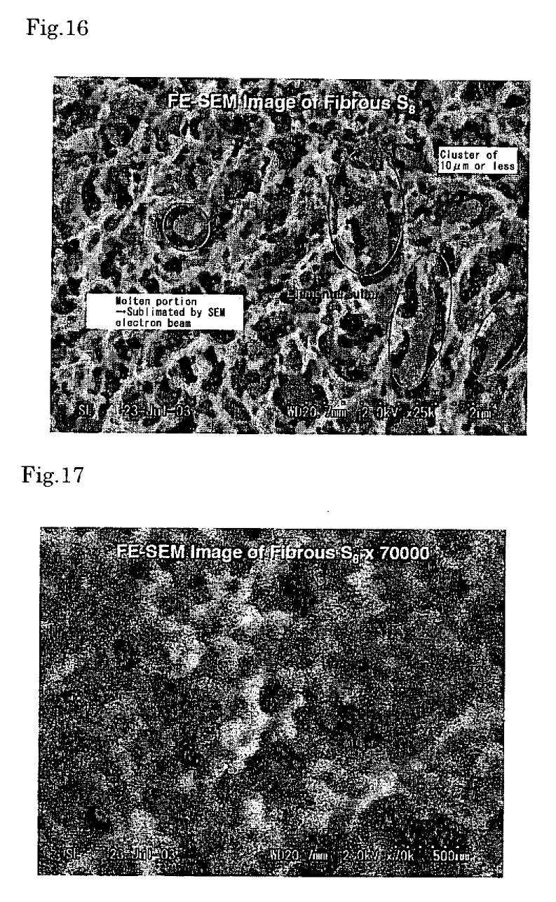

FIG. 14 is a photo (×200) of the fibrous intermediate composite substance, which was taken using the scanning electron microscope (SEM). The obtained fibrous intermediate composite substance had a diameter of about 2 μm. FIG. 15 is a photo (×2000) of the fibrous intermediate composite substance, which was taken using the scanning electron microscope (SEM). A vein-like pattern appeared on the substance surface. FIG. 16 is a photo (×25000) of the fibrous intermediate composite substance, which was taken using the scanning electron microscope (SEM). A mass of elemental sulfur with a size of about 10 μm appeared. The three-dimensional network structure of carbon derived from Ketjen Black was confirmed.

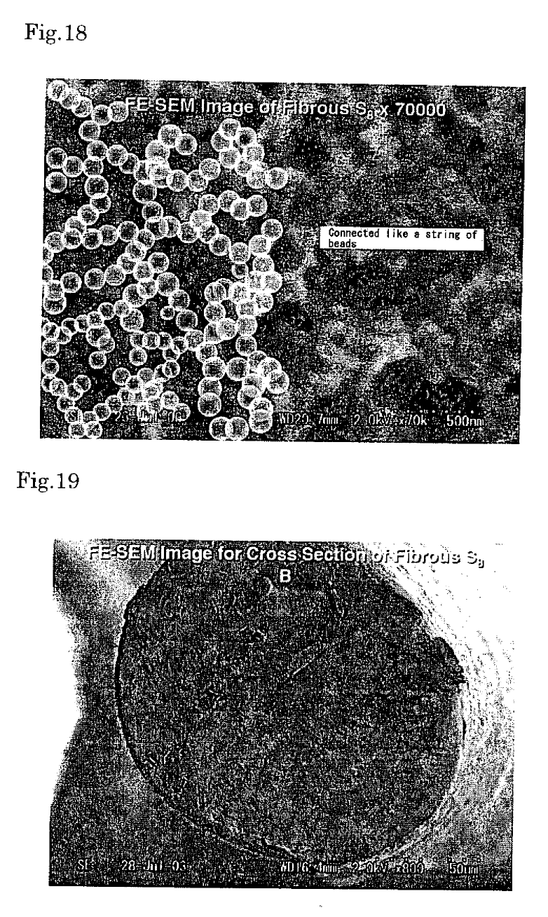

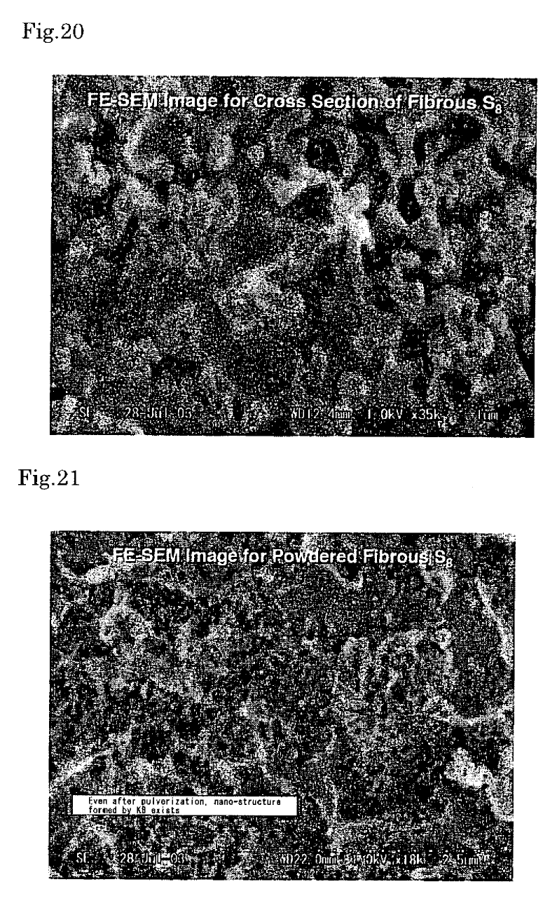

FIGS. 17 and 18 are each a photo (×70000) of the fibrous intermediate composite substance, which was taken using the scanning electron microscope (SEM). The three-dimensional network structure of carbon derived from Ketjen Black was confirmed. FIG. 19 is a photo (×800) of the fibrous intermediate substance in the direction of a cross-section, which was taken using the scanning electron microscope (SEM). FIG. 20 is a photo (×35000) of the fibrous intermediate substance in the direction of the cross-section, which was taken using the scanning electron microscope (SEM). A mass of elemental sulfur with a size of 2 μm or less and the three-dimensional network structure of carbon derived from Ketjen Black were also confirmed in the direction of the cross-section.

FIG. 21 is a photo (×18000) of the pulverized particles the fibrous intermediate substance, which was taken using the scanning electron microscope (SEM). Even after the pulverization, a mass of elemental sulfur with a size of 2 μm or less and the three-dimensional network structure of carbon derived from Ketjen Black were confirmed.

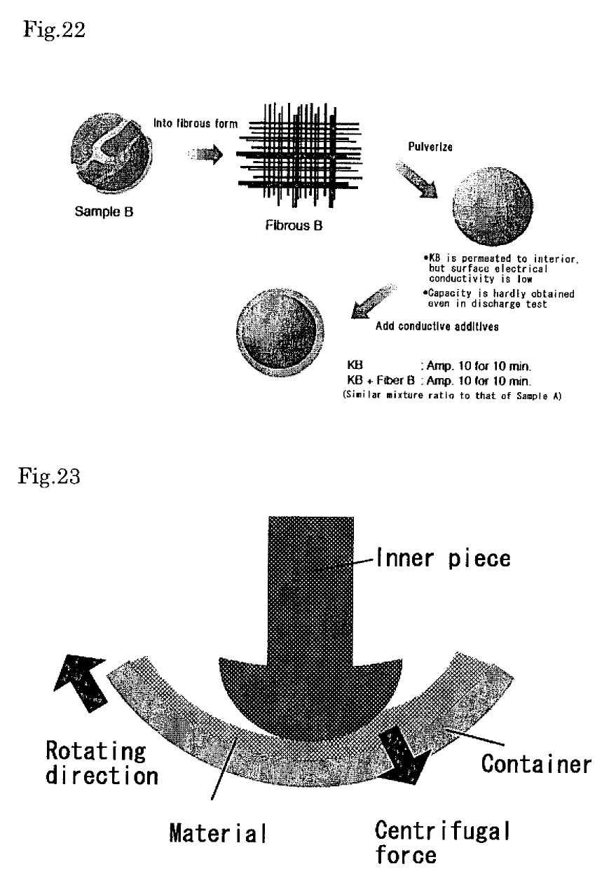

After pulverizing the fibrous intermediate composite substance, produced as shown in FIG. 13, into particles, Ketjen Black was further added, as shown in FIG. 22, so that the proper carbon proportion in the composite substance was obtained. The pulverized particles of the fibrous intermediate composite substance and Ketjen Black were added and mixed with each other using a ball mill (made by Retsch), and the resulting composite substance was used as the fibrous composite substance.

A higher operating voltage can also be realized by using an organic polysulfide compound instead of the elemental sulfur. Further, an even higher operating voltage can be realized by performing microwave irradiation and polymerization to organic polysulfide in a combined manner. While the discharge voltage in the battery using the elemental sulfur is about 2.0-2.3 V, the discharge can be realized at an operating voltage of 3.3-3.6 V in a battery produced with the combined use of microwave irradiation and polymerization to organic polysulfide.

Preferred Examples, Comparative Example, and Reference Example of the present invention will be described below. It is, however, to be noted that the following Examples merely show preferred examples of the present invention, and the present invention is not limited to the following Examples.

### REFERENCE EXAMPLE 1

### Production and Identification of Composite Substance of Sulfur and Ketjen Black, which has Composite Microparticle Layer where Microparticles of Ketjen Black are Intruded into Particles of Elemental Sulfur

In Reference Example 1, a mechanochemical bonding (MCB) process was used as a process for uniformly coating a nano-size thin layer of Ketjen Black around the sulfur-based compound. As shown in FIG. 23, the mechanochemical bonding process has an effect of producing a bond and a composite state close to a chemical bond by utilizing mechanical and physical forces. The combining technique by the mechanochemical bonding process is able to produce composite particles with strong bonds among nano-size particles by the action of excitation energy newly applied.

FIG. 31 shows a mixture ratio of the elemental sulfur to Ketjen Black when the Ketjen Black is coated around the elemental sulfur by the mechanochemical bonding process. More specifically, FIG. 31 shows a weight ratio of the sulfur compound to Ketjen Black (W_{sulfur}/W_{Ketjen Black}), a weight proportion of the sulfur-based compound, and a theoretical specific capacity per composite substance. Note that Samples A, B and C, shown in FIG. 31, represent composite substances A, B and C, respectively.

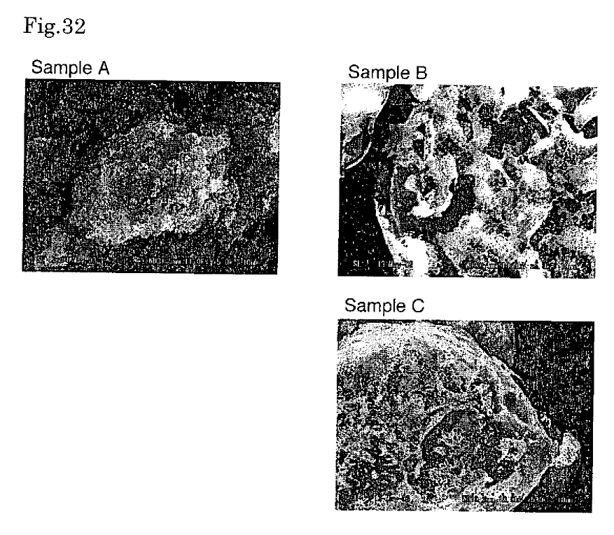

FIG. 32 shows photos of the composite substances A, B and C produced by coating Ketjen Black around the sulfur compound by mechanochemical bonding process, which were taken using the scanning electron microscope. Each of the composite substances A to C had a composite state where the elemental sulfur was coated over an entire surface with the Ketjen Black in a three-dimensional mesh-like structure. It is understood that the Ketjen Black coating the sulfur compound forms a regular three-dimensional mesh-like structure by the mechanochemical bonding process, and therefore micro-size voids are formed around the composite particles.

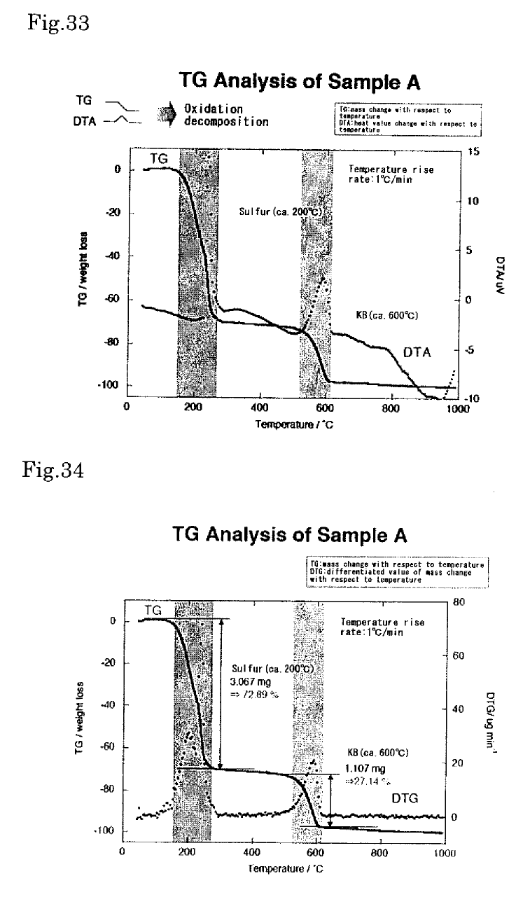

FIG. 33 shows the result of a thermal analysis of the composite substance A. In FIG. 33, a TG curve represents change of mass with respect to a temperature rise, and a DTA curve represents change of a heat value with respect to a temperature rise. The temperature rise rate was set to 1° C. min¹. With the temperature rise, the mass change and an increase of the heat value due to oxidation decomposition of the composite substance A and the Ketjen Black appeared at 200° C. and 600° C., respectively.

FIG. 34 shows the results of reading weights of the sulfur compound and Ketjen Black in the composite substance A from a mass decrease obtained by the thermal analysis.

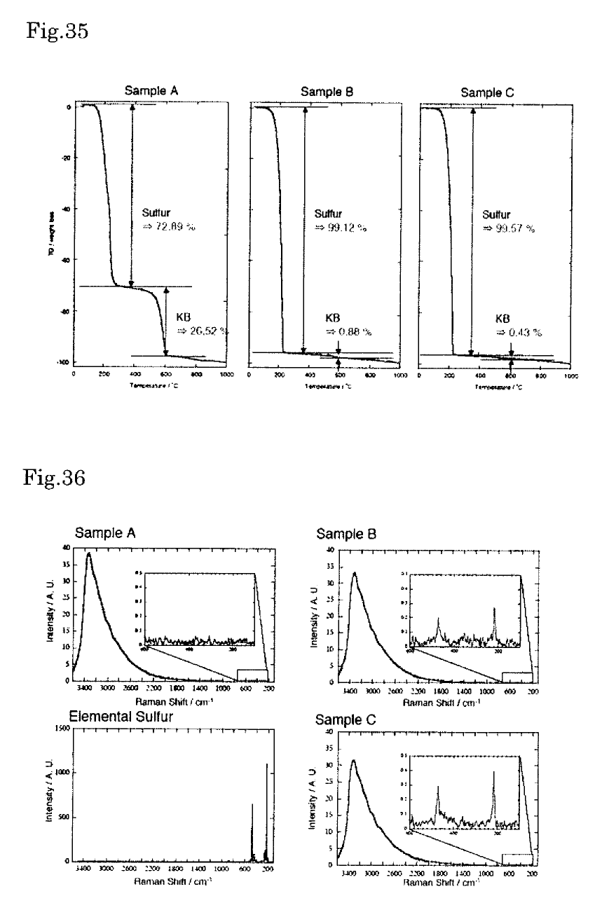

FIG. 35 shows the results of mass decreases of the composite substances A to C with respect to a temperature rise. More specifically, FIG. 35 shows the results of calculating weights of the sulfur compound and Ketjen Black in each of those composite substances from the results of mass decreases with respect to a temperature rise.

Table 1 shows proportions of the sulfur compound and the Ketjen Black in the composite substances A to C, which are obtained from the results of thermal analyses thereof. More specifically, Table 1 shows mixture ratios between the sulfur compound and the Ketjen Black mixed in the composite substances A to C and mixture ratios obtained from the results of thermal analyses thereof. The produced conductive substances A to C had substantially the same mixture ratios as those in the mixed state.

TABLE 1
Weight ratio of each sample A, B and C by TG measurement

| | |
|---|---|
| | Measurement |
| | weight |
| Mixture | ratio |
| ratio/% | from TG/% |

| Sample | Sulfur | KB | Sulfur | KB |
|---|---|---|---|---|
| A | 72.89 | 27.14 | 73.47 | 26.52 |
| B | 99.17 | 0.83 | 99.12 | 0.88 |
| C | 99.84 | 0.16 | 99.57 | 0.43 |
| Fibrous B | | | 99.00 | 0.10 |

Table 2 shows the density and conductivity of each of the composite substances A to C. The density of the composite state was reduced with the mixture ratio of the Ketjen Black increasing. Also, the conductivity showed a larger value with the mixture ratio of the Ketjen Black increasing. The conductivity of the composite substance A was about 8 S·cm⁻¹. The conductivity of the Ketjen Black was about 10 S·cm⁻¹. Those results mean that, in the composite substance A, the Ketjen Black substantially uniformly coats the particles of the sulfur compound.

TABLE 2

| | | | | S:KB = 73:27 |
|---|---|---|---|---|
| | Sample A | Sample B | Sample C | (=Sample A) |
| Weight/g | 0.05 | 0.05 | 0.05 | 0.05 |
| Thickness/μm | 476 | 380 | 32.5 | 392 |
| Density/gcm⁻³ | 1.3 | 1.7 | 2.0 | 1.6 |
| Conductivity/Scm⁻¹ | 8.4 × 10⁰ | 1.9 × 10⁻² | 2.7 × 10⁻¹ | 4.7 × 10⁰ |

Conductivity of KB: 1.057 × 10¹ Scm⁻¹
1. Density was reduced at larger added amount of KB
2. Conductivity was increased at larger added amount of KB
3. MCB provided higher conductivity than Ball Mixing

FIG. 36 shows Raman spectra of the composite substances A to C and the elemental sulfur. For the elemental sulfur, peaks appear at 218 cm⁻¹ and 417 cm⁻¹. For the composite substances A to C, a broad peak appears at 3328 cm⁻¹. This broad peak represents the Ketjen Black. The peaks of 218 cm⁻¹ and 417 cm⁻¹ do not appear for the composite substance A. The peaks of 218 cm⁻¹ and 417 cm⁻¹ appear for the composite substances B and C.

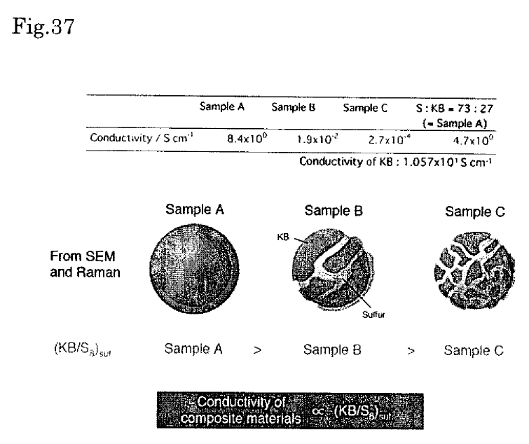

FIG. 37 illustrates images showing coated states of the composite substances A to C. From the conductivity and the Raman spectrum, it is inferred that, in the composite substance A, the Ketjen Black uniformly coats the surfaces of elemental sulfur particles. Also, it is inferred that, in the composite substances B and C, the Ketjen Black coats the elemental sulfur particles in a state where the elemental sulfur is partly exposed.

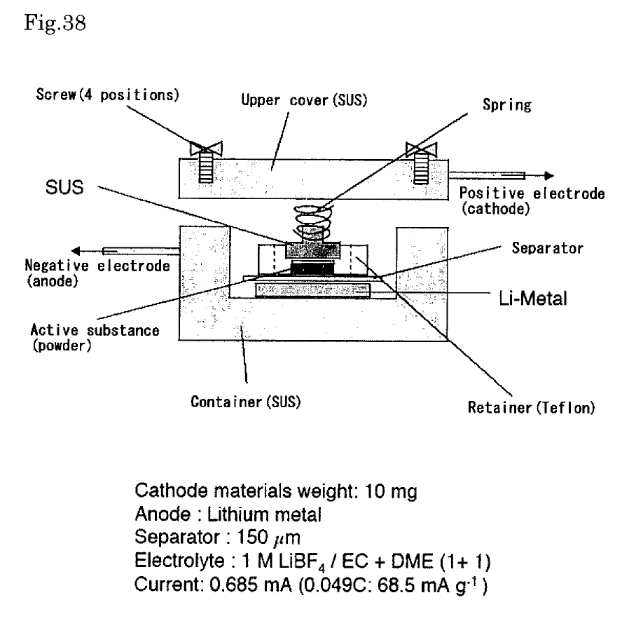

The discharge capacities of the composite substances A to C were measured using a screwed-in battery cell shown in FIG. 38. A lithium metal (made by Honjo Metal Co., Ltd.) was used as the negative electrode, and a separator (made by Nippon Kodoshi Corporation) with a thickness of 150 μm was impregnated with an electrolyte which was prepared by dissolving 1-M lithium tetrafluoroborate (made by Kishida Chemical Co., Ltd.) in a mixed solvent (made by Kishida Chemical Co., Ltd.) of ethylene carbonate and 1,2-dimethoxyethane (1:1).

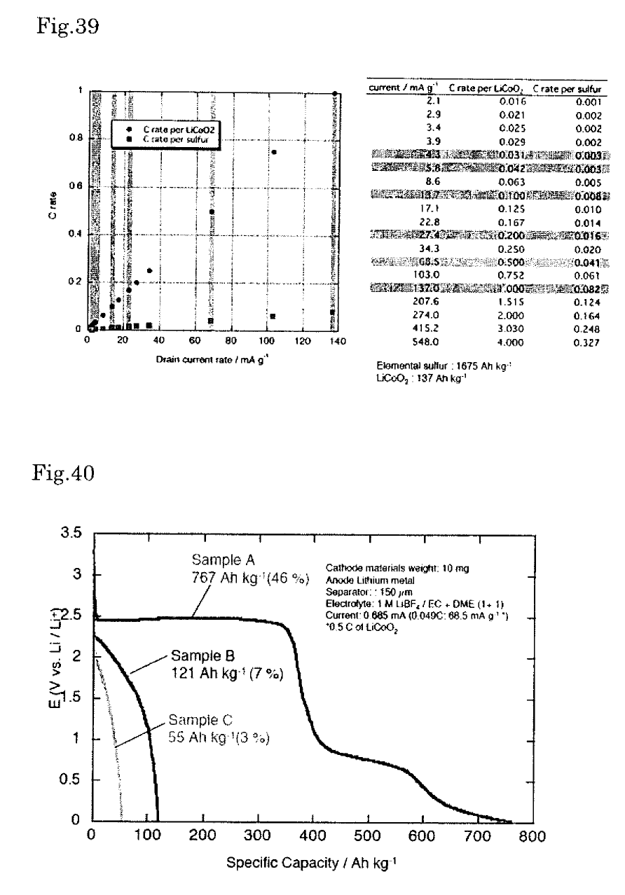

The discharge capacities of the composite substances A to C in the battery cells were measured by a constant current process. FIG. 39 shows current densities per weight of the composite substances A to C in the battery cells when the discharge capacities are measured. The term “C rate” is defined such that 1 C represents the current density required for charging or discharging a theoretical capacity of 100% for 1 hour, When evaluating materials having different theoretical capacities, the current densities differ from each other even at the same C rate. The C rates of lithium cobalt oxide, which is a material of the currently-used positive electrode of the lithium ion secondary battery, and the elemental sulfur are comparatively shown in FIG. 42 when the current density (mA g⁻¹) is the same.

FIG. 40 shows the discharge curves and corresponding specific capacities of the composite substances A to C in the battery cells.

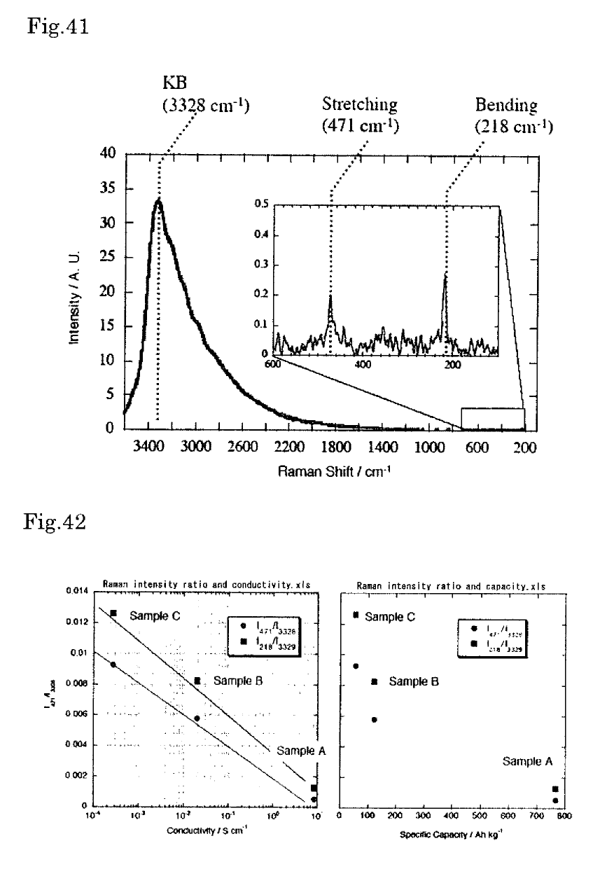

As shown in FIG. 41, peak intensity ratios are calculated between 471 cm⁻¹ and 3328 cm⁻¹ (I₄₇₁/I₃₃₂₈) and between 218 cm⁻¹ and 3328 cm⁻¹ (I₂₁₈/I₃₃₂₈) in Raman spectra of the composite substances A to C. Because the peak intensity ratios are calculated from the peaks (218 cm⁻¹ and 471 cm⁻¹) of elemental sulfur and the peak (3328 cm⁻¹) of Ketjen Black, the Raman peak intensity ratios indicate respective rates at which the elemental sulfur and the Ketjen Black are exposed to the composite substance surface.

FIG. 42 shows the relationships between the Raman peak intensity ratios (I₄₇₁/I₃₃₂₆ and I₂₁₈/I₃₃₂₈) of elemental sulfur to Ketjen Black and the conductivities and between the Raman peak intensity ratios and the specific capacities. As seen from the plotted relationship, the conductivity increases linearly as the rate of the peak intensity (I₃₃₂₈) of Ketjen Black increases, i.e., as the Raman peak intensity ratio (I₄₇₁/I₃₃₂₈ or I₂₁₈/I₃₃₂₈) reduces. Also, the specific capacity in the discharge state increases as the rate of the peak intensity (I₃₃₂₈) of Ketjen Black increases, i.e., as the Raman peak intensity ratio (I₄₇₁/I₃₃₂₈ or I₂₁₈/I₃₃₂₈) reduces.

### REFERENCE EXAMPLE 2

### Production and Identification of Fibrous Intermediate Composite Substance

FIG. 13 shows one example of a process for producing the fibrous intermediate composite substance. The composite substance (B is used herein as one example) is heated to 160-165° C. By holding the temperature of 160-165° C., the composite substance is brought into a fluidized state. The composite substance B in the fluidized state is stirred and elongated. After elongating the intermediate composite substance B in the fluidized state, it is cooled to the room temperature. The surface and cross-section of a formed fibrous intermediate composite substance B′ are observed using a scanning electron microscope. Further, the formed fibrous intermediate composite substance B′ is pulverized and resulting particles are observed using the scanning electron microscope.

FIG. 14 is a photo (×200) of the fibrous intermediate composite substance B′, which was taken using the scanning electron microscope (SEM). The obtained fibrous intermediate composite substance B′ had a diameter of about 2 μm. FIG. 15 is a photo (×2000) of the fibrous intermediate composite substance B′, which was taken using the scanning electron microscope (SEM). A vein-like pattern appeared on the substance surface. FIG. 16 is a photo (×25000) of the fibrous intermediate composite substance B′, which was taken using the scanning electron microscope (SEM). A mass of elemental sulfur with a size of about 10 μm appeared. The three-dimensional network structure of carbon derived from Ketjen Black was confirmed. FIGS. 17 and 18 are each a photo (×70000) of the fibrous intermediate composite substance B′, which was taken using the scanning electron microscope (SEM). The three-dimensional network structure of carbon derived from Ketjen Black was confirmed. FIG. 19 is a photo (×800) of the fibrous intermediate substance B′ in the direction of a cross-section, which was taken using the scanning electron microscope (SEM). FIG. 20 is a photo (×35000) of the fibrous intermediate substance B′ in the direction of the cross-section, which was taken using the scanning electron microscope (SEM). A mass of elemental sulfur with a size of 2 μm or less and the three-dimensional network structure of carbon derived from Ketjen Black were also confirmed in the direction of the cross-section. FIG. 21 is a photo (×18000) of the pulverized particles the fibrous intermediate substance B′, which was taken using the scanning electron microscope (SEM). Even after the pulverization, a mass of elemental sulfur with a size of 2 μm or less and the three-dimensional network structure of carbon derived from Ketjen Black were confirmed.

### Production and Identification of Conductive Fibrous Composite Substance having Three-Dimensional Network Structure Constituted by Microparticles of Conductive Substance, which Coat Surface of Fibrous Intermediate Composite Substance Serving as Core

After pulverizing the fibrous intermediate composite substance B′, produced as shown in FIG. 13, into particles, Ketjen Black was further added, as shown in FIG. 22, so that the carbon proportion in the composite substance A was obtained. The pulverized particles of the fibrous intermediate composite substance B′ and Ketjen Black were added and mixed with each other using a ball mill (made by Retsch), and the resulting composite substance was used as the fibrous composite substance A.

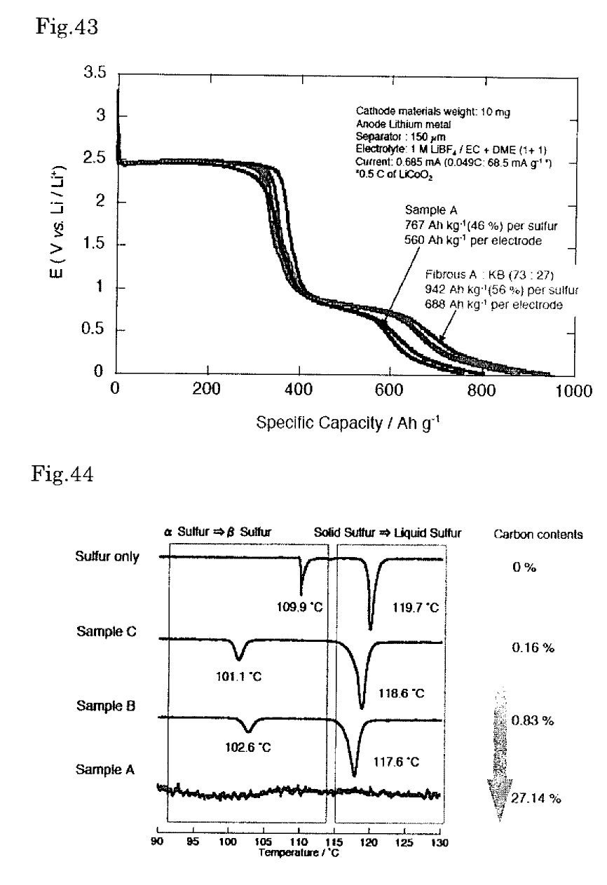

FIG. 43 shows discharge curves and corresponding specific capacities of the composite substance A and the fibrous composite substance A in battery cells.

### Evaluation of Mixed State and Composition of Each Sample by Thermal Analysis

FIG. 12 shows endothermic changes of elemental sulfur with respect to a temperature rise. At 110° C., an endothermic reaction occurs corresponding to phase change from monoclinic sulfur to rhombic sulfur. At 120° C., an endothermic reaction occurs corresponding to melting. At 160° C., an endothermic reaction occurs corresponding to polymerization. FIG. 44 shows endothermic changes of sulfur only and the composite substances A to C with respect to a temperature rise up to 130° C. As the proportion of Ketjen Black in the composite substance increases, the temperature of the endothermic reaction corresponding to the phase change from monoclinic sulfur to rhombic sulfur lowers. Also, as the proportion of Ketjen Black in the composite substance increases, the temperature of the endothermic reaction corresponding to the melting lowers.

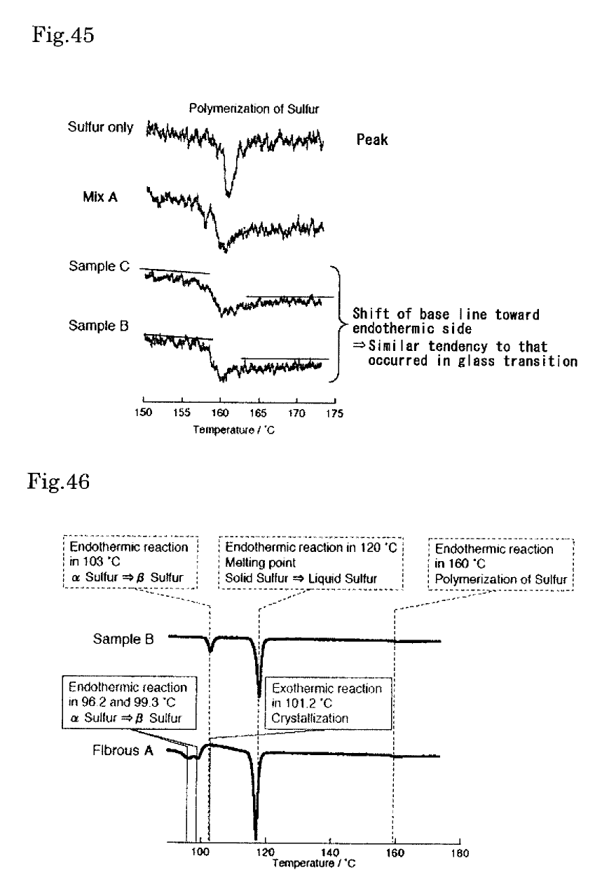

FIG. 45 shows endothermic changes of sulfur only, the fibrous composite substance A, and the composite substances B, C with respect to a temperature rise of 150 to 175° C. For sulfur only, an endothermic peak corresponding to polymerization appears near 160° C. For the composite substances B and C, a shift of the base line toward the endothermic side appears.

FIG. 46 shows differential thermal changes of the composite substance B and the fibrous composite substance A with respect to a temperature rise. For the fibrous composite substance A, the temperature of the endothermic reaction corresponding to the phase change from monoclinic sulfur to rhombic sulfur start to lower at lower temperature than the case of the composite substance B.

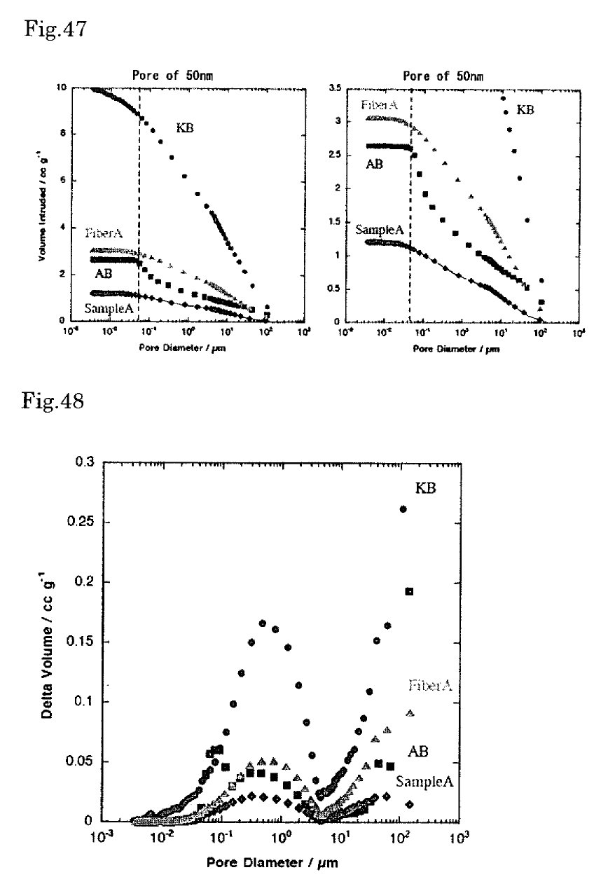

FIG. 47 shows the results of pore areas per weight with respect to pore distributions of Ketjen Black, acetylene black, the fibrous composite substance A, and the composite substance A, which were measured using a mercury intrusion porosimeter (made by Yuasa Ionics Co., Ltd.). Ketjen Black had a pore area per weight much larger than acetylene black. The fibrous composite substance A had a pore area per weight larger than the composite substance A.

FIG. 48 shows the distribution results of pore areas per weight with respect to pore distributions of Ketjen Black, acetylene black, the fibrous composite substance A, and the composite substance A, which were measured using the mercury intrusion porosimeter (made by Yuasa ionics Co., Ltd.).

Table 3 shows pore volumes, porosities, and specific surface areas of Ketjen Black, acetylene black, the fibrous composite substance A, and the composite substance A, which were measured using the mercury intrusion porosimeter (made by Yuasa Ionics Co., Ltd.).

TABLE 3

| | Pore | | Specific |
|---|---|---|---|
| Sample name | volume/ccg⁻¹ | Porosity/% | surface area/m²g⁻¹ |
| KB | 9.917 | 90.0 | 380.6 |
| AB | 2.649 | 70.0 | 58.9 |
| Sample A(MCB) | 1.207 | 70.3 | 22.8 |
| Fiber A | 3.060 | 82.1 | 39.8 |

*Specific surface area of KB at BET is 1270 m²g⁻¹

[symbol]

Reflect liquid permeable range

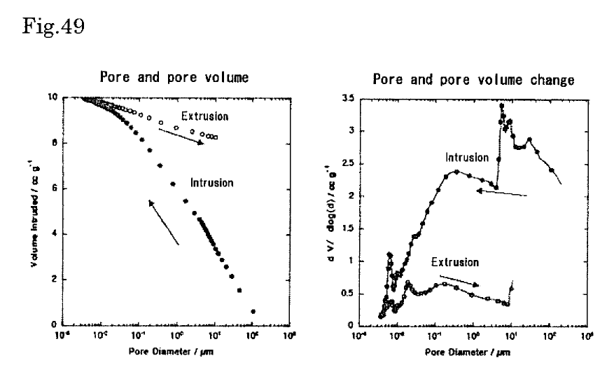

FIG. 49 shows changes of pore volume and changes of pore volume distribution with respect to the pore distribution of Ketjen Black, which were measured by the mercury intrusion/extrusion process.

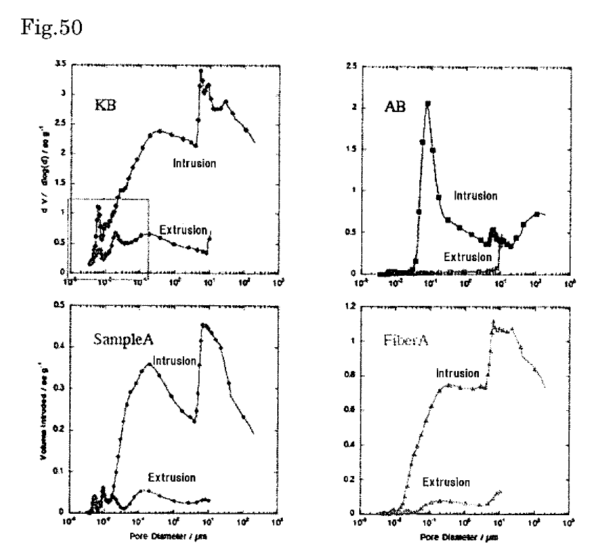

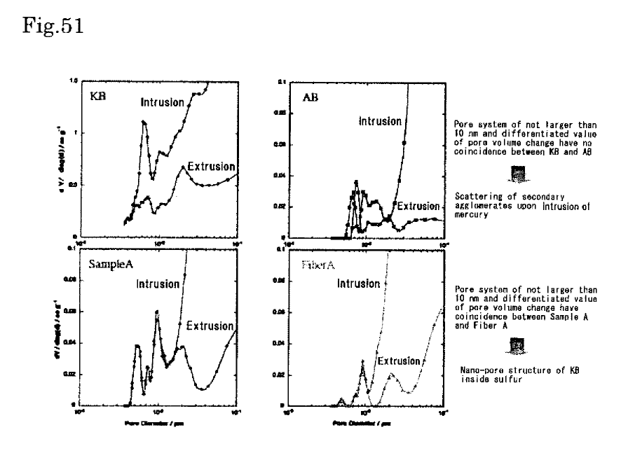

FIG. 50 shows changes of pore volumes and changes of pore volume distributions with respect to the pore distributions of Ketjen Black, acetylene black, the fibrous composite substance A, and the composite substance A, which were measured by the mercury intrusion/extrusion process. FIG. 51 shows changes of pore volumes and changes of pore volume distributions with respect to the pore distributions of Ketjen Black, acetylene black, the fibrous composite substance A, and the composite substance A in the range of 1 nm to 100 nm, which were measured by the mercury intrusion/extrusion process. Because behaviors of the intrusion and the extrusion of mercury with respect to the change of pore distribution show no coincidence between Ketjen Black and acetylene black, it is inferred that secondary agglomerates were scattered away upon the intrusion of mercury. Because behaviors of the intrusion and the extrusion of mercury show coincidence between the composite substance A and the fibrous composite substance A in the 1-10 nm range of pore distribution, it is inferred that pores formed by Ketjen Black are present inside the elemental sulfur.

### EXAMPLE 1

In this Example 1, a comparative test of discharge capacity was made on a positive electrode A made of a composite substance of sulfur and conductive carbon black and produced by the mechanofusion, and a positive electrode B made of the same materials and produced by the wet process.

### Materials Used

Each of the positive electrode A and the positive electrode B contained 72.9 weight % of sulfur and 27.1 weight % of carbon microparticles. Commercially available Ketjen Black was used as the carbon microparticles of the positive electrode A. Most commonly used acetylene black was used for the positive electrode B.

### Production of Positive Electrode Materials

The positive electrode A was produced, as shown in FIG. 23, through the steps of loading the sulfur and the carbon microparticles into a rotating container, and applying strong shearing forces, compression, and breaking stress to the loaded materials between an inner roll and a wall surface of the container, thereby producing a composite substance with a mechanochemical reaction. As a result, the positive electrode material A was obtained in which the carbon microparticles were combined in the form of a thin coating layer with the surfaces of sulfur particles. The produced positive electrode material A had a diameter of about 10 μm.

The positive electrode B was produced by the known process of mixing the carbon material serving as conductive additives and the sulfur by using a ball mill. The ball mill is a pulverizer of the type that a pulverizing medium is put in a cylindrical drum and the drum is rotated to pulverize a supplied material. Because the ball mill has a simple structure and is easy to handle, it is used in a very wide range including both of the dry and wet processes.

### Identification of Composite Substance A and Composite Substance B

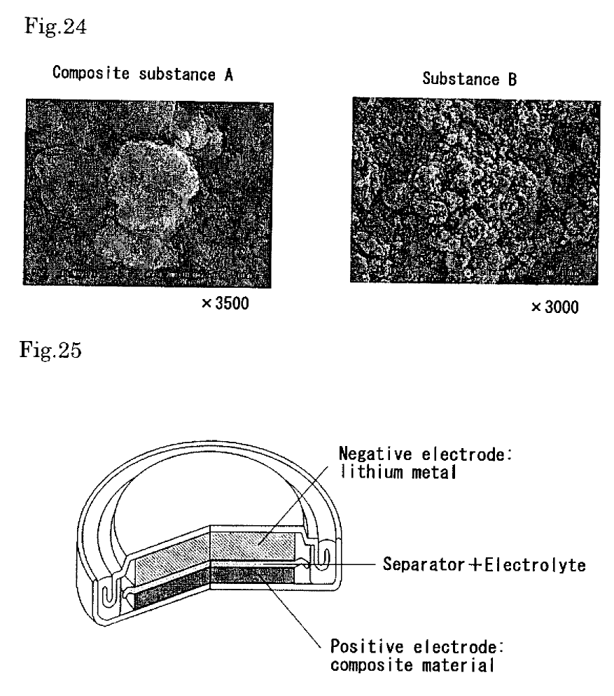

FIG. 24 shows SEM images of the composite substance A and the substance B. As seen from the SEM images, in the composite substance A, the very finely dispersed Ketjen Black uniformly covers the surfaces of the sulfur particles. On the other hand, in the substance B produced using the ball mill, the acetylene black is dispersed in an agglomerated state, and therefore carbon particles non-uniformly cover the surfaces of the sulfur particles.

### Measuring Method

The positive electrode A was formed by using the composite substance A as a positive electrode material, and the positive electrode B was formed by using the substance B as a positive electrode material. Then, a comparative test of discharge capacity was made on each of the positive electrode A and the positive electrode B.

Electrode performance of each of the positive electrode materials A and B was evaluated using a coin-shaped battery cell shown in FIG. 25. A lithium metal (made by Honjo Metal Co., Ltd.) was used as the negative electrode, and a separator (made by Nippon Kodoshi Corporation) with a thickness of 150 μm was impregnated with an electrolyte which was prepared by dissolving 1-M lithium tetrafluoroborate (made by Kishida Chemical Co., Ltd.) in a mixed solvent (made by Kishida Chemical Co., Ltd.) of ethylene carbonate and 1,2-dimethoxyethane (1:1).

A battery with a diameter of 20 mm was fabricated by using 10 mg of each of the positive electrode materials A and B as a battery positive electrode material, the lithium metal with a thickness of 0.3 mm as a battery negative electrode material, and a nonwoven fabric with a thickness of 150 μm as a separator layer, which was impregnated with an electrolyte prepared as 0.1 ml of the mixed solvent of 1,3-dioxolane and 1,2-dimethoxyethane at a volume ratio of 1:1 by dissolving 1-M lithium tetrafluoroborate therein. Each of the thus-fabricated batteries was placed at the room temperature of 20° C. and was discharged over a range of 3-0 V at a constant current of 0.7 mA.

### Measurement Results

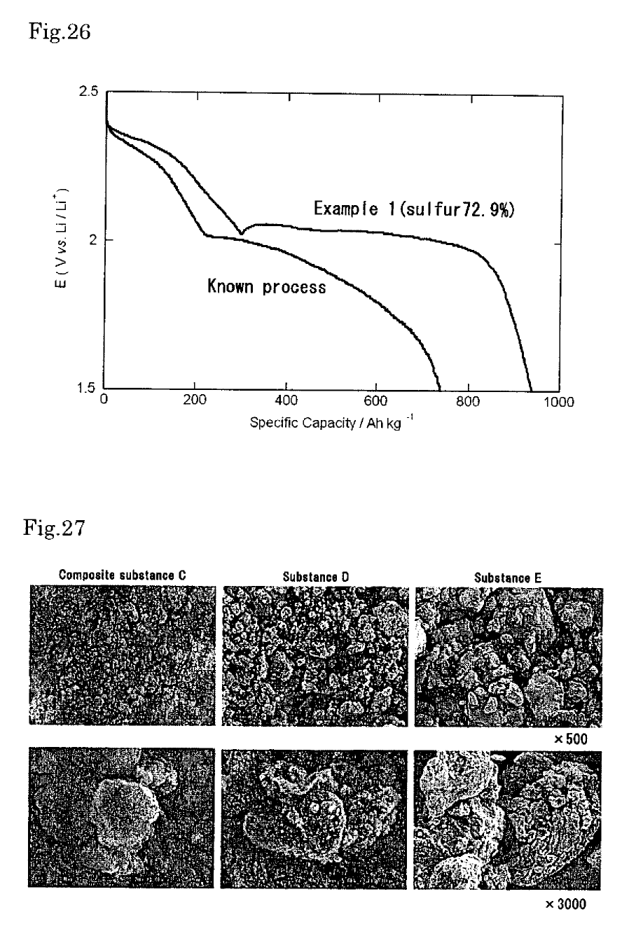

FIG. 26 shows the results of evaluating the discharge capacities (unit: Ah/kg) measured by the discharge tests made on the respective positive electrode materials. As seen from FIG. 26, the positive electrode material A according to Example 1 can generate the discharge capacity about 1.3 times that of the positive electrode material B having the same composition.

### EXAMPLE 2

1. In this Example 2, 73 weight % of sulfur and 27 weight % of Ketjen Black (registered trademark) were mixed in accordance with different production processes to obtain a composite substance C of the sulfur and the Ketjen Black, a substance D as Comparative Example 2, a substance E as Comparative Example 3.

The composite substance C was obtained with pulverization using Mechanochemical Bonding (by Hosokawa Powder Technology Research Institute). The substance D of Comparative Example 2 was obtained with pulverization (Amplitude=10 rpm) for 5 minutes using the ball mill (made by Retsch). The substance E of Comparative Example 3 was obtained with pulverization (Amplitude=100 rpm) for 5 minutes using the ball mill (made by Retsch).

2. Identification of Composite Substance C, Substance D, and Substance E

FIG. 27 shows SEM images of the composite substance C, the substance D, and the substance E, which were observed at magnifications of 500 and 3000 times for each image. As seen from the SEM images, in the composite substance C, the very finely dispersed Ketjen Black uniformly covers the surfaces of the sulfur particles. On the other hand, in the substance D produced using the ball mill, the Ketjen Black is dispersed in an agglomerated state, and therefore carbon particles non-uniformly cover the surfaces of the sulfur particles. It is hence inferred that the non-uniform coating of the Ketjen Black makes the substance D bulky. In the substance E produced using the ball mill, no particles of the Ketjen Black appeared on the substance surface. It is hence inferred that a part of the sulfur itself is dissolved by strong pulverizing forces and re-agglomeration of the dissolved sulfur is caused.

3. Measuring Method and Measurement Results C

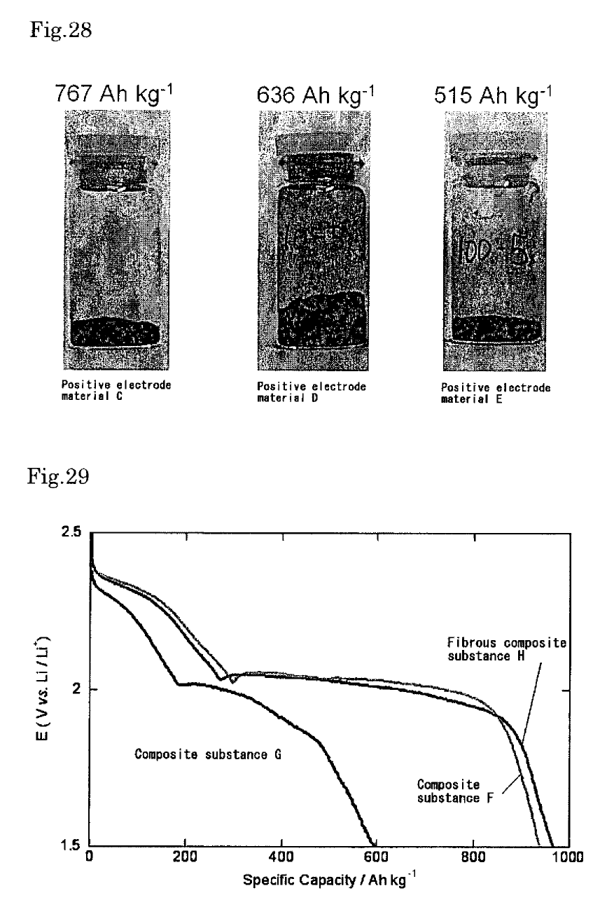

A positive electrode C was formed by using the composite substance C as a positive electrode material, a positive electrode D was formed by using the substance D as a positive electrode material, and the electrode E was formed by using the substance E as a positive electrode material. Then, a comparative test of discharge capacity was made on the positive electrode materials C, D and E in a similar manner to that in Example 1. The test results are shown in FIG. 28. As seen from FIG. 28, the positive electrode material C can generate the highest output of 767 Ah/kg in spite of having the smallest volume.

### EXAMPLE 3

In this Example 3, a comparative test of discharge capacity was made on positive electrodes F and G each made of a composite substance of sulfur and conductive carbon black and produced by the mechanofusion, as well as a positive electrode H made of a fibrous which was produced through the steps of applying physical stress to a heated intermediate composite substance, cooling the heated intermediate composite substance to the room temperature, pulverizing it, and performing mechanofusion of pulverized particles with an conductive additives.

1. Materials Used

The positive electrode F contained 73 weight % of sulfur and 27 weight % of carbon microparticles. Each of the positive electrodes G and H contained 84 weight % of sulfur and 16 weight % of carbon microparticles. Commercially available Ketjen Black was used as the carbon microparticles of the positive electrodes F to H.

2. Production of Positive Electrode Materials

The positive electrodes F and G were each produced, as shown in FIG. 23, through the steps of loading the sulfur and the carbon microparticles into the rotating container, and applying strong shearing forces, compression, and breaking stress to the loaded materials between the inner roll and the wall surface of the container, thereby producing a composite substance with a mechanochemical reaction. As a result, the positive electrodes F and G were obtained in each of which the carbon microparticles were combined as a thin coating layer with the surfaces of sulfur particles. The produced positive electrode materials had diameters of about 10 μm.

The positive electrode G was produced through a first step of mixing 99.1 weight % of sulfur and 0.9 weight % of Ketjen Black by mechnofusion, a second step of heating the composite substance, formed in the first step, to temperature of 160-165° C. not lower than the melting point of the sulfur or the sulfur compound, a third step of applying physical stress to the composite substance in a heated state by stirring or elongation, a fourth step of rapidly cooling the heated composite substance, a fifth step of pulverizing the cooled composite substance, and a sixth step of mixing pulverized particles of the composite substance with Ketjen Black by mechnofusion so as to provide a composition of 84.8 weight % of sulfur and 15.2 weight % of Ketjen Black.

3. Identification of Composite Substances F, G and Fibrous Composite Substance H

In each of the composite substances F and G, the Ketjen Black was combined with the surfaces of the sulfur particles by the mechnofusion. In the fibrous composite substance H, the Ketjen Black as the conductive substance was coated over the surfaces of the pulverized particles of the fibrous intermediate composite substance, as shown in FIGS. 15-19, by the mechnofusion.

4. Measuring Method

Electrode performance of each of the positive electrode materials F, C and H was evaluated using a coin-shaped battery cell shown in FIG. 25. A lithium metal (made by Honjo Metal Co., Ltd.) was used as the negative electrode, and a separator (made by Nippon Kodoshi Corporation) with a thickness of 150 μm was impregnated with an electrolyte which was prepared by dissolving 1-M lithium tetrafluoroborate (made by Kishida Chemical Co., Ltd.) in a mixed solvent (made by Kishida Chemical Co., Ltd.) of ethylene carbonate and 1,2-dimethoxyethane (1:1).

A battery with a diameter of 20 mm was fabricated by using 10 mg of each of the positive electrode materials F and G as a battery positive electrode material, the lithium metal with a thickness of 0.3 mm as a battery negative electrode material, and a nonwoven fabric with a thickness of 150 μm as a separator layer, which was impregnated with an electrolyte prepared as 0.1 ml of the mixed solvent of 1,3-dioxolane and 1,2-dimethoxyethane at a volume ratio of 1:1 by dissolving 1-M lithium tetrafluoroborate therein. Each of the thus-fabricated batteries was placed at the room temperature of 20° C. and was discharged over a range of 3-0 V at a constant current of 0.7 mA.

5. Measurement Results

FIG. 29 shows the results of comparing the discharge capacities per weight. As seen from FIG. 29, although the composite substance G and the fibrous composite substance H each contained 84 weight % of sulfur, the fibrous composite substance H can generate the discharge capacity about 1.6 times that of the composite substance G.

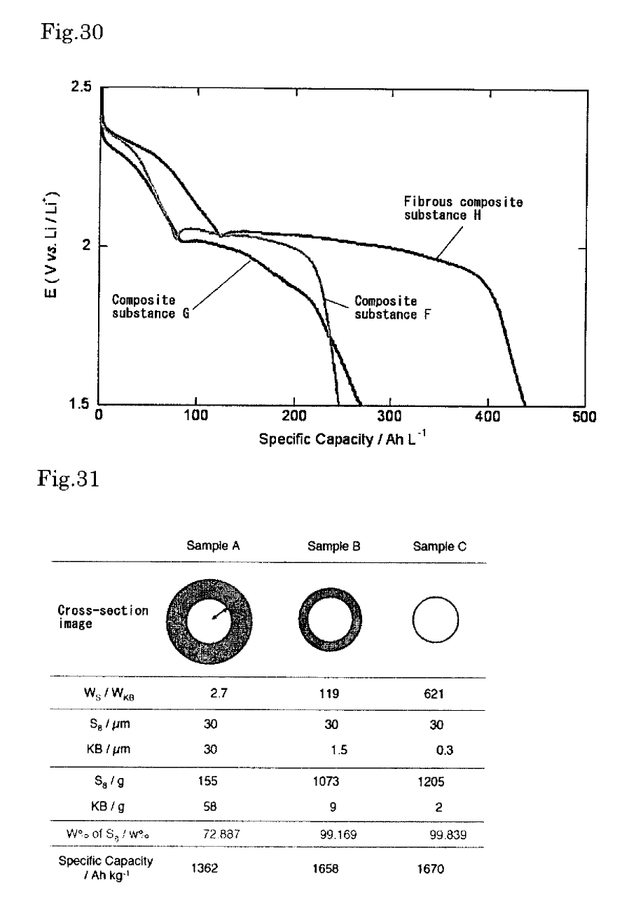

FIG. 30 shows the results of comparing the discharge capacities per volume. As seen from FIG. 30, at the same volume, the fibrous composite substance H can generate the electric capacity about 1.8 times that of the composite substance G and can generate the discharge capacity about 1.7 times that of the composite substance F.

1. (canceled)

2. A battery positive electrode material comprising a composite of a conductive substance and sulfur and/or a sulfur compound having an S—S bond, the battery positive electrode material including a composite microparticle layer formed in a state that micropartiees of the conductive substance are intruded into particles of the sulfur and/or the sulfur compound having an S—S bond,
wherein the composite microparticle layer is a composite microparticle layer closely compacted onto surfaces of the particles of the sulfur and/or the sulfur compound having an S—S bond, which serve as core, while ensuring sufficient electron and ion conduction paths.

3. A battery positive electrode material according to claim 2, wherein, in a state of raw materials, the particles of the sulfur and/or the sulfur compound having an S—S bond have particle diameters of 75 μm or less, and the microparticles of the conductive substance are carbon microparticles with primary particle diameters of 30 nm to 50 nm.

4. A battery positive electrode material according to claim 3, wherein the carbon microparticles have a hollow structure with a porosity of 60 Vol % to 80 Vol %.

5. A battery positive electrode material according to claim 2, wherein the composite contains the sulfur and/or the sulfur compound having an S—S bond at a content of 70 weight % or more in terms of sulfur.

6. A battery positive electrode material according to claim 5, wherein the composite contains the sulfur and/or the sulfur compound having an S—S bond at a content of 72.9 weight % or more in terms of sulfur.

7. A battery positive electrode material according to claim 2, wherein the composite has electric conductivity of 10⁰ to 10¹ S·cm⁻¹ or more.

8. A battery positive electrode material according to claim 2, wherein an volumetric energy density is 1000 to 4000 Wh/L and an volumetric power density is 40 to 4000 W/L.

9. A process for producing a battery positive electrode material, the process comprising the step of performing mechnofusion of particles of sulfur and/or a sulfur compound having an S—S bond with microparticles of a conductive substance, which are used as raw materials, thereby obtaining a composite substance having a composite microparticle layer in which the microparticles are intruded into the particles, the composite microparticle layer being a composite microparticle layer closely compacted onto surfaces of the particles of the sulfur and/or the sulfur compound having an S—S bond, which serve as core, while ensuring sufficient electron and ion conduction paths.

10. A process for producing a battery positive electrode material according to claim 9, wherein, in a state of the raw materials, the particles of the sulfur and/or the sulfur compound having an S—S bond have particle diameters of 75 μm or less, and the microparticles of the conductive substance are carbon particles with primary particle diameters of 30 nm to 50 nm.

11. A process for producing a battery positive electrode material according to claim 9, wherein the carbon microparticles have a hollow structure with a porosity of 60 Vol % to 80 Vol %.

12. A process for producing a battery positive electrode material according to claim 9, wherein the composite contains the sulfur and/or the sulfur compound having an S—S bond at a content of 72.9 weight % or more in terms of sulfur.

13. A battery positive electrode material made of a conductive fibrous composite substance which is produced by using the battery positive electrode material according to claim 2 as a starting composite substance, heating the starting composite substance to temperature not lower than the melting point thereof, applying physical stress to the composite substance in a heated state by stirring or elongation, cooling the heated composite substance to the room temperature, to thereby produce a fibrous intermediate composite substance, pulverizing the fibrous intermediate composite substance, and performing mechnofusion of pulverized particles of the fibrous intermediate composite substance with the microparticles of the conductive substance, thereby producing a three-dimensional network structure derived from the microparticles of the conductive substance on surfaces of the pulverized particles of the fibrous intermediate composite substance which serve as core.

14. A process for producing a battery positive electrode material, the process comprising:
a first step of preparing, as raw materials, particles of sulfur and/or a sulfur compound having an S—S bond with a content of 70 weight % or more in terms of sulfur and microparticles of a conductive substance, and performing mechnofusion of the particles with the microparticles, thereby producing a composite substance of the sulfur and/or the sulfur compound having an S—S bond and the conductive substance with a composite microparticle layer of the particles and the microparticles closely compacted onto surfaces of the particles, which serve as core, while ensuring sufficient electron and ion conduction paths;
a second step of heating the produced composite substance to temperature not lower than the melting point thereof;
a third step of applying physical stress to the composite substance in a heated state by stirring or elongation;
a fourth step of cooling the heated composite substance to the room temperature;
a fifth step of pulverizing a fibrous intermediate composite substance obtained in the fourth step; and
a sixth step of performing mechnofusion of pulverized particles of the fibrous intermediate composite substance with the microparticles of the conductive substance, thereby producing a conductive fibrous composite substance having a three-dimensional network structure derived from the microparticles of the conductive substance on surfaces the pulverized particles of the fibrous intermediate composite substance which serve as core.
